(19) United States
(12) Patent Application Publication
(10) Pub. No.: US 2010/0282196 A1
(43) Pub. Date: Nov. 11, 2010

(54) METHOD FOR OPERATING A LASER AS AN IGNITION DEVICE OF AN INTERNAL COMBUSTION ENGINE

(76) Inventor: Heiko Ridderbusch, Schwieberdingen (DE)

Correspondence Address: KENYON & KENYON LLP, ONE BROADWAY, NEW YORK, NY, 10004, US

(21) Appl. No.: 12/733,668

(22) PCT Filed: Sep. 4, 2008
(86) PCT No.: PCT/EP2008/061658

§ 371 Date: Jul. 22, 2010

(30) Foreign Application Priority Data
Sep. 28, 2007 (DE) 102007046647.3

(51) Int. Cl. F02B 19/00; F02D 28/00

(52) U.S. Cl. 123/143 B; 701/102

(57) ABSTRACT

A method for operating a laser as an ignition device of an internal combustion engine, the laser including at least one laser crystal, a passive Q-switch and at least one pump device, particularly a laser diode, which optically pumps the laser crystal using pump radiation; at a temperature of the laser crystal below an operating boundary temperature, the pump radiation being changed, compared to a normal operation, in such a way that, compared to the normal operation, a greater radiation energy is converted to heat in the laser crystal.

### FIELD OF THE INVENTION

The present invention relates to a method for operating a laser as an ignition device of an internal combustion engine, a laser for the ignition of an internal combustion engine, as well as a computer program for carrying out the method.

### BACKGROUND INFORMATION

A laser ignition system for Otto engines is known, for example, from German Patent No. DE-OS 28 49 458. In currently known laser ignition systems for Otto engines for motor vehicles and large stationary engines, the laser-active solids are either not tempered, in which case they assume the temperature of the environment, or they are brought to a desired temperature, using diverse cooling or heating systems, such as electric heating, or the like. In the first case, there is the possibility of influencing the temperature of the laser crystals, and in the second case, relatively costly heating systems, for instance, having electrical heating elements for the laser crystals or the gas or liquid media, are used for heating the laser crystals.

The energy output of a passively Q-switched laser is a function of the temperature of the laser crystal. Without an active cooling system or heating system, the temperature of the laser crystal is a function of the environmental temperature and the heat applied by the optical pumping procedure. The energy output may thus be exposed to very strong fluctuations, especially in the field of application of a passenger car, which has a possible temperature range of −40° C. (as during a cold start in wintertime) to 160° C. (operationally heated internal combustion engine), so that the emitted pulse energy is perhaps not sufficient to ignite the mixture in a combustion chamber, or, if necessary, to burn the combustion chamber window free of deposits.

### SUMMARY OF THE INVENTION

Without an active cooling system or heating system, the temperature of the laser crystal is a function of the environmental temperature and the heat applied by the optical pumping procedure. Therefore, one object of the present invention is to provide a possibility of tempering laser crystals in laser ignition systems for Otto engines that is cost-effective and simple to implement.

This object is attained by a method for operating a laser as an ignition device of an internal combustion engine, the laser including at least one laser crystal, a passive Q-switch and at least one pump device, particularly a laser diode, which optically pumps the laser crystal using pump radiation; at a temperature of the laser crystal below an operating boundary temperature, the pump radiation being changed, compared to a normal operation, in such a way that, compared to the normal operation, a greater radiation energy is converted to heat in the laser crystal. The operating boundary temperature is a minimum temperature, ascertained experimentally, for example, at which laser pulses are able to be generated which lead to a sufficiently sure ignition of the gas/air mixture in a combustion chamber of an internal combustion engine. As long as the laser system is operated below the laser threshold, the energy applied to the laser crystal by pump radiation is converted to heat.

The temperature of the laser resonant cavity is preferably increased by changing the intensity and/or the pumping duration of the pump radiation. The intensity and/or the pumping duration are changed in such a way, in this instance, that as large as possible a proportion of the applied energy is converted to heat.

The pump radiation preferably includes pump pulses as well as pump prepulses. The pump pulses are used to generate laser pulses for igniting the gas/air mixture in the combustion chamber of the internal combustion engine, and the prepulses essentially for heating the laser crystal.

The maximum intensity of the pump prepulses is preferably less than the intensity of the pump pulses. The intensity of the pump prepulses is designed so that the point in time of the laser pulse emitted by the laser is not changed, or only slightly so. It is preferably provided that the prepulse has a pulse duration of more than 2 ms, or even a pulse duration that corresponds to the distance in time of two successive ignitions, that is, the prepulse is made up of continuous radiation. The prepulse preferably has a pulse duration of 100 μs to 2 ms.

The object named at the outset is also attained by a laser for an ignition of an internal combustion engine, the laser including at least one laser crystal, a passive Q-switch and at least one pump device, especially a laser diode, which optically pumps the laser crystal using pump radiation, wherein, at a temperature of the laser crystal below an operating boundary temperature, the pump radiation is changed, compared to the normal operation, in such a way that a greater quantity of heat, compared to normal operation, is applied to the laser crystal.

The object set forth above is also attained by a computer program having program code for carrying out all of the steps according to a method of the present invention when the program is executed on a computer.

### BRIEF DESCRIPTION OF THE DRAWINGS

FIG. 1 shows a schematic sketch of an internal combustion engine.

FIG. 2 shows a schematic sketch of a laser.

FIG. 3 shows a diagram of the pump intensity over time of a method according to the related art.

FIG. 4 shows a diagram of the pump intensity over time of a method according to the present invention.

FIG. 5 shows a diagram of an effective cross section of the stimulated emission, as well as the pulse energy plotted against the crystal temperature of a laser crystal.

### DETAILED DESCRIPTION

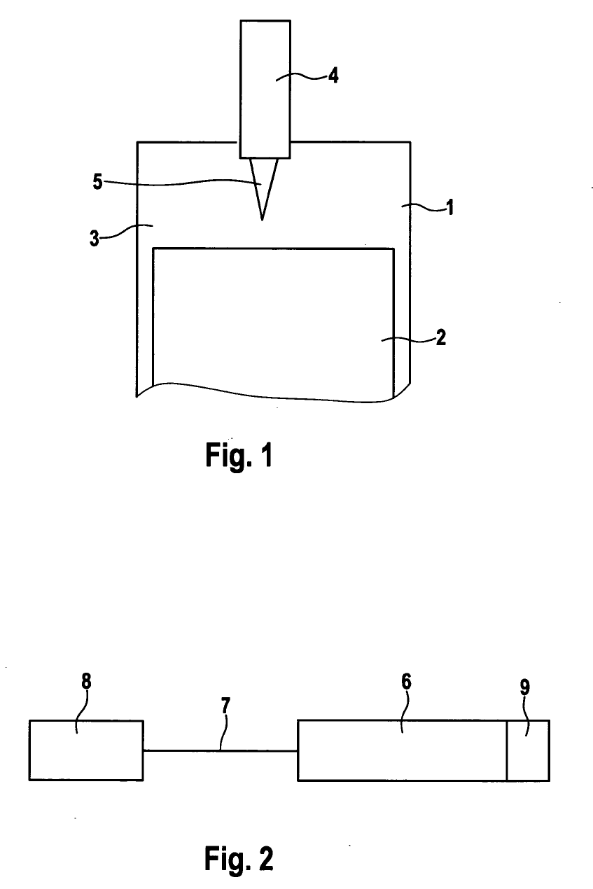

FIG. 1 shows schematically a cylinder of an internal combustion engine, in which a piston 2 is movably situated. Cylinder 1 and piston 2 form a combustion chamber 3. A combustible mixture is applied to combustion chamber 3, through an intake duct and appropriate valves, which is ignited. This causes a pressure rise in combustion chamber 3, which causes a motion of piston 2. The motion of piston 2 is transformed into a rotational motion, by a crankshaft, which is then used to drive a motor vehicle or the like. In the schematic representation of FIG. 1, the crankshaft, the fresh air channel, the exhaust air channel, corresponding valves and the like are not shown, since this is not essential for an understanding of the present invention. In the representation of FIG. 1, a usual Otto engine is involved. The ignition of the combustible fuel/air mixture present in combustion chamber 3 takes place using a laser 4, which applies a focused laser beam 5 to combustion chamber 3, and thus forms a laser ignition. At focal point 6, the energy of the laser beam is focused on a small point which, at focal point 6, leads to very high temperatures. This temperature increase takes place abruptly in response to the use of the laser beam, and leads to a very hot plasma in focal point 6, which then effects the ignition of the combustible mixture contained in combustion chamber 3.

As is shown schematically in FIG. 2, laser 4 includes a laser crystal 6 which is connected on one side to a laser diode 8, using a pump fiber 7, which acts as an optical pump. On the other side of laser crystal 6 there is situated a passive Q-switch 9, for example, a CR4+:YAG Q-switch. Laser crystal 6 is an Nd:YAG, for instance. The laser resonant cavity is formed by mirrors M1 and M2. The design of the laser according to FIG. 2 is known per se, so that we do not have to go into details on its operating mode at this point. Because of the quantum defect, known also as the Stokes Shift, the entire excitation energy applied by optical pump 8 to laser crystal 6 is not converted to the excitation of ions. The part of the pump energy converted to heat may be estimated by Q=1−pump wavelength/emission wavelength. The emission wavelength is always greater than the pump wavelength, that is, a pump photon has more energy than a photon from the actual laser system, in practice, the heat loss for usual four-level systems being approximately 30% and for usual three-level systems being approximately 12%. In the case of a durable pumping power of about 100 Watt, in laser crystal 6; thus, between 12 Watt and 30 Watt are converted to heat. The laser crystal is heated up using this converted heat.

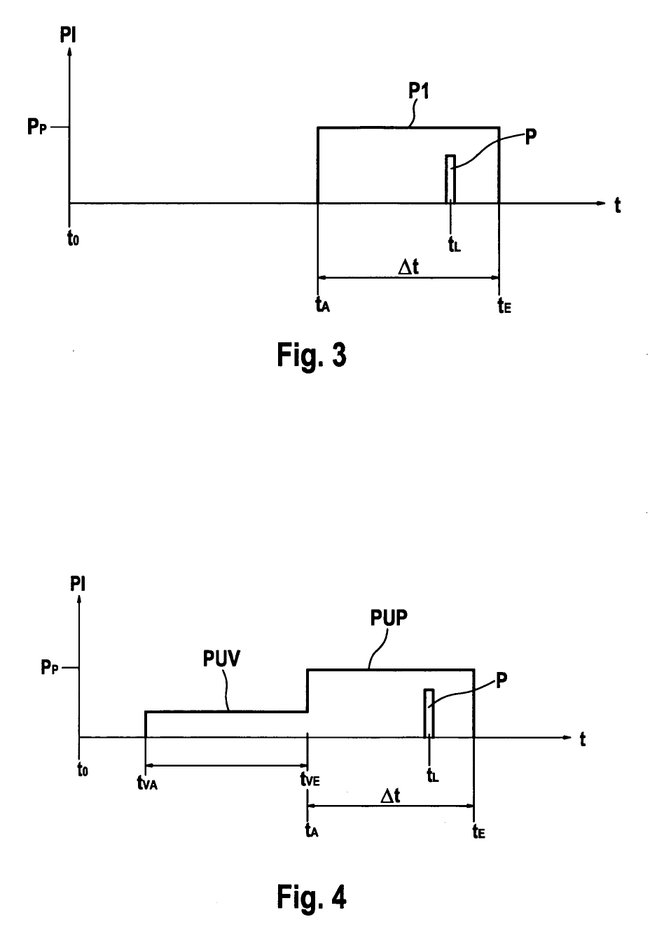

FIG. 3 shows a diagram of pump intensity PI over time t, as is known from the related art. Pump intensity PI is the pump power of laser diode 8 over time t. Laser crystal 6 is pumped intermittently between a time t₀ and a time tₐ. Now, if the pumping power is 0, then at a subsequent time span tₐ to tₑ, pump intensity PI is approximately constant at a value P_{P}. At a time tₗ, because of the optical pumping by laser crystal 6, a laser pulse P is emitted. Time span Δt between times tₐ and tₑ amounts to about 100 microseconds to 2 milliseconds.

According to the present invention, before the actual pump pulse PUP, a prepulse PUV is applied by pump element 8 to laser crystal 6. Prepulse PUV may be an individual pulse or a sequence of pulses, but it may also be a continuous wave (continuous wave CW). In view of its intensity PI and its length between the beginning at time tᵥₐ and its end tᵥₑ, prepulse PUV is designed so that the emission of laser pulse P is not changed or is changed only insubstantially with respect to its time. The end of prepulse PUV tᵥₑ and the beginning of pump pulse PUP at time tₐ may coincide, in this context. The sequence of pump pulse PUP and prepulse PUV may be alternating, in this instance, so that the pump source continuously gives off light power, and with that, also heat power to laser crystal 6.

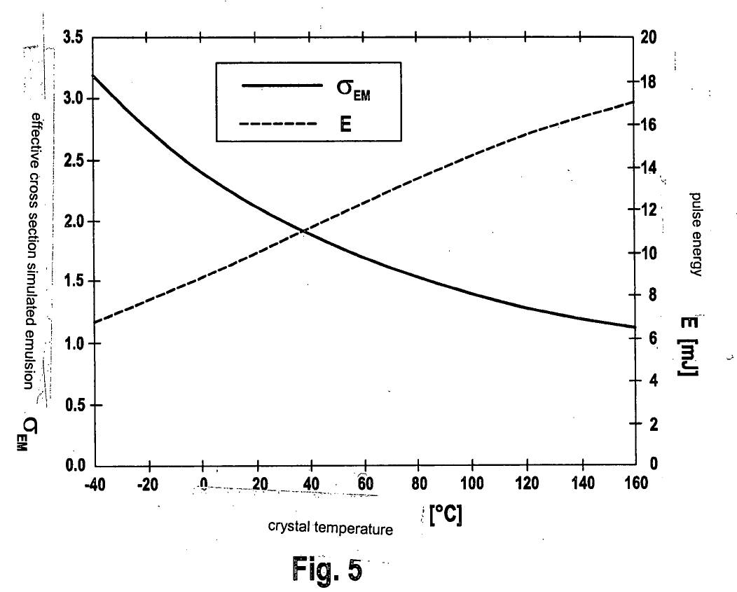

FIG. 5 shows a diagram of an effective cross section of the stimulated emission, as well as the pulse energy plotted against the crystal temperature of a laser crystal. On the abscissa, crystal temperature Tₖ is plotted in ° C., and on the ordinate, on the left, the effective cross section of stimulated emission σₑₘ, and on the right, pulse energy E is plotted in mJ. Dashed curve E designates the pulse energy, solid curve σₑₘ designates the effective cross section of the stimulated emission, in each case plotted against the crystal temperature in ° C. What may be seen is a drop in σₑₘ with rising temperature, i.e.

$$\frac{d σ}{d T}$$

is negative. This means that pulse energy E of a passively Q-switched laser system increases with increasing temperature, as shown in FIG. 5.

The illustration in FIG. 5 shows that an energy of 10 mJ is achievable at 20° C. in the present example. At a crystal temperature of −40° C., such a laser system is only able to achieve a pulse energy of barely 7 mJ which, under certain circumstances may be too low for a sure ignition. In the case of typical temperatures of about 100° C., conditioned, for example, by the cooling water of the internal combustion engine, the system is able to emit a pulse energy of 14 mJ. For the cleaning of the combustion chamber window or for operating points determined for this, one may possibly need more energy, such as 17 mJ, which is achievable only at higher temperatures, in this case, as shown, at 160° C.

Therefore, an operating boundary temperature Tₘᵢₙ is established, below which the laser crystal is preheated by pump radiation. If a sure ignition above a pulse energy of 14 mJ is fulfilled using the number values given as an example above, the laser crystal is preheated at a temperature below 100° C. as operating boundary temperature, as described above. As the temperature of the laser crystal, one may utilize approximately, for example, the outside temperature, the oil temperature or the temperature of the cooling liquid of an internal combustion engine. The operating boundary temperature is ascertained experimentally, and is stored as a constant, for instance, in a control unit of the internal combustion engine.

1-10. (canceled)

11. A method for operating a laser as an ignition device of an internal combustion engine, the laser including at least one laser crystal, a passive Q-switch and at least one pump device, the method comprising:
at a temperature of the laser crystal below an operating boundary temperature, changing a pump radiation, compared to a normal operation, in such a way that, compared to the normal operation, a greater radiation energy is converted to heat in the laser crystal.

12. The method according to claim 11, wherein the pump device includes a laser diode which optically pumps the laser crystal using the pump radiation.

13. The method according to claim 11, further comprising increasing the temperature of the laser crystal by changing at least one of an intensity and a pumping duration of the pump radiation.

14. The method according to claim 11, wherein the pump radiation includes pump pulses and pump prepulses.

15. The method according to claim 14, wherein a maximum intensity of the pump prepulses is less than an intensity of the pump pulses.

16. The method according to claim 15, wherein an intensity of the pump prepulses is such that a point in time of a laser pulse emitted by the laser is substantially not changed.

17. The method according to claim 14, wherein the pump prepulses have a pulse duration of more than 2 ms.

18. The method according to claim 17, wherein the pump prepulses have continuous radiation.

19. The method according to claim 17, wherein the pump pulses have a pulse duration of 100 μs to 2 ms.

20. A laser for an ignition of an internal combustion engine, comprising:
at least one laser resonant cavity including a laser crystal;
a passive Q-switch; and
at least one pump device,
wherein, at a temperature of the laser crystal below an operating boundary temperature, a pump radiation is changed, compared to a normal operation, in such a way that, compared to the normal operation, a greater quantity of heat is applied to the laser resonant cavity.

21. The laser according to claim 20, wherein the pump device includes a laser diode which optically pumps the laser resonant cavity using the pump radiation.

22. A computer-readable medium containing a computer program which when executed by a processor performs a method for operating a laser as an ignition device of an internal combustion engine, the laser including at least one laser crystal, a passive Q-switch and at least one pump device, the method comprising:
at a temperature of the laser crystal below an operating, boundary temperature, changing a pump radiation, compared to a normal operation, in such a way that, compared to the normal operation, a greater radiation energy is converted to heat in the laser crystal.
